(19) United States
(12) Patent Application Publication
(10) Pub. No.: US 2001/0051487 A1
(43) Pub. Date: Dec. 13, 2001

(54) Method for making organic luminescent device

(76) Inventors: Yuichi Hashimoto, Tokyo (JP); Kouichi Suzuki, Kanagawa (JP); Akihiro Senoo, Kanagawa (JP); Hiroshi Tanabe, Kanagawa (JP); Kazunori Ueno, Kanagawa (JP); Seiji Mashimo, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/836,369

(22) Filed: Apr. 18, 2001

(30) Foreign Application Priority Data
Apr. 26, 2000 (JP) 125347/2000(PAT.)

(51) Int. Cl. H05B 33/10

(52) U.S. Cl. 445/24; 313/504

(57) ABSTRACT

In a method for making an organic luminescent device, a first electrode is formed on a substrate by applying a DC voltage to the first electrode without generation of plasma. An organic layer is formed on the first electrode. Furthermore, a second electrode is formed on the organic layer. The resulting organic layer exhibits improved charge injection from the anode and the organic luminescent device exhibits significantly high luminance.

### BACKGROUND OF THE INVENTION

1. Field of the Invention

The present invention relates to a method for making a luminescent device.

2. Description of the Related Art

Pope et al., first discovered electroluminescence (EL) in an organic material, that is, single-crystal anthracene, in 1963 (J. Chem. Phys., 38, 2042 (1963)). Subsequently, Helfinch and Schneider observed relatively strong EL in an injection EL material containing a solution electrode system having a high injection efficiency in 1965 (Phys. Rev. Lett., 14, 229 (1965)).

Studies of organic luminescent materials containing conjugated organic hosts and conjugated organic activators having condensed benzene rings have been disclosed in U.S. Pat. Nos. 3,172,862, 3,173,050, and 3,710,167; J. Chem. Phys., 50, 14364 (1969); J. Chem. Phys., 44, 2902 (1966); J. Chem. Phys., 58, 1542 (1973); and Chem. Phys. Lett., 36, 345 (1975). Examples of disclosed organic hosts include naphthalene, anthracene, phenanthrene, tetracene, pyrene, benzpyrene, chrysene, picene, carbazole, fluorene, biphenyl, terphenyl, triphenylene oxide, dihalobiphenyl, transstilbene, and 1,4-diphenylbutadiene. Examples of disclosed activators include anthracene, tetracene and pentacene. Since these organic luminescent materials are provided as single layers having a thickness of more than 1 μm, a high electric field is required for luminescence.

Under these circumstances, thin film devices formed by a vacuum deposition process have been proposed (for example, in “Thin Solid Films”, p. 94 (1982); Polymer, 24, 748 (1983); and J. Appl. Phys., 25, L773 (1986)). Although the thin film devices are effective in reducing the driving voltage, their luminance is far from levels required for practical use.

In recent years, Tang, et al., have developed an EL device having a high luminance at a low driving voltage (Appl. Phys. Lett., 51, 913 (1987) and U.S. Pat. No. 4,356,429). The EL device is fabricated by depositing, by a vacuum deposition process, two very thin layers, that is, a charge transport layer and a luminescent layer, between an anode and a cathode. Such layered organic EL devices are disclosed in, for example, Japanese Patent Application Laid-Open Nos. 59-194393, 63-264692, and 3-163188, U.S. Pat. Nos. 4,539,507 and 4,720,432, and Appl. Phys. Lett., 55, 1467 (1989).

Also, an EL device of a triple-layered structure having a carrier transport function and a luminescent function separately provided was disclosed in Jpn. J. Appl. Phys., 27, L269 and L713 (1988). Since the carrier transportability is improved in such an EL device, the selection of usable dyes in the luminescent layer is considerably increased. Further, the device configuration suggests that improvements in luminescence by effectively trapping holes and electrons (or excimers) in the central luminescent layer are feasible.

Layered organic EL devices are generally formed by vacuum deposition processes. EL devices having considerable luminance are also formed by casting processes (as described in, for example, Extended Abstracts (The 50th Autumn Meeting (1989), p. 1006 and The 51st Autumn Meeting (1990), p. 1041; The Japan Society of Applied Physics). Considerably high luminance is also achieved by a single-layered mixture-type EL device, in which the layer is formed by immersion-coating from a solution containing polyvinyl carbazole as a hole transport compound, an oxadiazole derivative as an electron transport compound, and coumarin-6 as a luminescent material, as described in Extended Abstracts of the 38th Spring Meeting 1991, p. 1086, The Japan Society of Applied Physics and Related Societies.

As described above, the organic EL devices have been significantly improved and have suggested the feasibility of a wide variety of applications; however, these EL devices have some problems in practical use, for example, insufficient luminance, changes in luminance during prolonged use, and deterioration by atmospheric gas which is humid and contains oxygen.

ITO films (transparent conductive films) used as anodes in organic luminescent devices are increasingly required to have higher performance as their use becomes more widespread. In particular, the ITO film used as electrodes are required to have lower resistance and improved injection efficiency of charge into an organic layer.

In general, organic luminescent devices are electron-injection-type luminescent devices, and luminescence thereof is significantly dependent on the amount of carriers (holes or electrons) injected from electrodes. It is desirable that carrier injection from the electrodes (anode and cathode) be constant ever prolonged use.

In an actual ITO electrode used as an anode, a current flowing in a device by carrier injection from the electrode is reduced due to imperfect matching of electrical and physical characteristics as an electrode, such as the physical surface shape and the work function caused by the deposition process therefor, resulting in a significant decrease in optical output.

In a conventional process, an ITO film is generally formed on a substrate by a dry process, such as a vacuum deposition process or a sputtering process. Since the crystallinity of the resulting ITO film depends on the substrate temperature and the deposition rate during the deposition step, it is difficult to significantly improve the physical surface shape (surface roughness) and the work function of the ITO film relating to the crystal plane. Thus, it is difficult to improve the function (charge injection ability) of an electrode in an organic luminescent device.

Furthermore, it is desirable that the total thickness of the ITO film be 100 to 200 nm in order to achieve compatibility of area resistance and optical transparency. However, crystallization occurs during the deposition process in this conventional sputtering process, and the ITO film has an uneven surface in the order of several nm to several tens nm.

When an organic layer is deposited on such an ITO film by a vacuum deposition or the like, adhesiveness is inhibited at the interface between the uneven ITO film and the organic layer, resulting in significant deterioration of charge injection from the ITO film. Accordingly, the luminescent device exhibits low luminescent intensity and a decreased service life due to separation of the organic layer.

Japanese Patent Laid-Open No. 2000-150146 discloses a process for forming a plasma polymerization film by applying an acceleration voltage of 500 V or less to a substrate holder and moving a plasma CuPC (copper phthalocyanine) towards the substrate to deposit the compound onto the substrate surface. According to the knowledge of the present inventors, this plasma treatment will cause decomposition of the organic compound to be formed.

### SUMMARY OF THE INVENTION

It is an object of the present invention to provide a method for making an organic luminescent device showing improved properties by changing the state of a deposited organic layer to improve the physical and electrical contact between an electrode and the organic layer.

It is another object of the present invention to provide a method for making an organic luminescent device, which exhibits improved charge injection from an electrode and significantly high luminescent output, by applying a positive voltage to an anode and a negative voltage to a cathode of the organic luminescent device to control the state of the deposited organic layer.

According to an aspect of the present invention, a method for making an organic luminescent device includes the steps of forming a first electrode on a substrate, forming an organic layer on the first electrode, and forming a second electrode on the organic layer, wherein the organic layer is formed by applying a DC voltage to the first electrode without generation of plasma.

Preferably, the organic layer is formed by a dry process. More specifically, the organic layer is formed by a deposition process using resistance heating or laser ablation.

Preferably, the first electrode is driven as an anode of the organic luminescent device, and the DC voltage is a positive DC voltage. Alternatively, the first electrode is driven as a cathode of the organic luminescent device, and the DC voltage is a negative DC voltage.

Preferably, the anode comprises indium tin oxide (ITO).

Preferably, the first electrode is subjected to an oxygen plasma surface treatment or an inert gas plasma surface treatment, and then the organic layer is formed while the first electrode is driven as an anode of the organic luminescent device without exposing the first electrode in air.

Preferably, oxygen ions or electrons having an energy in the range of 10 to 80 eV are used in the oxygen plasma surface treatment. Preferably, positive ions of the inert gas having an energy in the range of 20 to 100 eV are used in the inert gas plasma surface treatment.

In this method, the DC voltage is preferably in the range of 10 to 100 V and more preferably in the range of 40 to 90 V.

The method in accordance with the present invention enables production of organic luminescent devices having high luminance. In addition, using an electrode (an ITO film) of which the surface is modified in plasma as an anode of an organic luminescent device significantly enhances luminance of the device.

Further objects, features and advantages of the present invention will become apparent from the following description of the preferred embodiments with reference to the attached drawings.

### BRIEF DESCRIPTION OF THE DRAWINGS

FIG. 1 is a schematic view of an apparatus for making an organic luminescent device based on the method in accordance with the present invention;

FIG. 2 is a cross-sectional view of an embodiment of an organic luminescent device produced according to the method of the present invention;

FIG. 3 is a cross-sectional view of another embodiment of an organic luminescent device produced according to the method of the present invention;

FIG. 4 is a cross-sectional view of another embodiment of an organic luminescent device produced according to the method of the present invention; and

FIG. 5 is a cross-sectional view of another embodiment of an organic luminescent device produced according to the method of the present invention.

### DESCRIPTION OF THE PREFERRED EMBODIMENT

The present invention will now be described in detail based on the following embodiments.

The formation of the organic layer will be described by an evaporation process, which is a typical dry deposition process.

In the method for making the organic luminescent device according to this embodiment, a positive DC voltage is applied to an ITO film as an anode; hence, an adhesive film is formed due to mutual electron transfer between organic clusters flying from an evaporation source and the ITO film. Since the ITO film is used as the electrode when the organic luminescent device is driven, the organic luminescent device can be readily produced such that no additional electrodes are provided.

When a DC voltage is applied, the organic layer can be reliably formed. Moreover, this voltage can be applied under the same conditions in which the device is driven.

In the organic layer having a mutlilayer configuration, performing film deposition while applying a DC voltage to the first electrode results in improved device characteristics, that is, improved physical adhesion and electronic contact between the organic films.

In the production of the organic luminescent device in which the first electrode is driven as the anode, when a significantly low positive DC voltage is applied to the anode, the advantages of the present invention are not achieved due to inhibited mutual electron transfer between the organic substances and the anode. When a significantly high voltage is applied, adhesiveness is impaired due to decomposition and oxidation of the organic substances. In order to achieve adequate electron transfer between the organic substances and the anode, the DC voltage is preferably in the range of 10 to 100 V and more preferably in the range of 40 to 90 V.

Preferably, the voltage is always applied without any particular process control when the organic layer is being formed on the anode. Alternatively, the voltage may be applied during the deposition process at least until the thickness of the organic layer deposited reaches 0.2 μm.

Preferably, the anode is subjected to an oxygen plasma surface treatment prior to the deposition of the organic layer in order to significantly improve the work function of the anode such as an ITO film. As a result, charge injection from the ITO film into the organic layer is enhanced.

In such a case, oxygen ions or electrons having an energy in the range of preferably 10 to 80 eV and more preferably 20 to 60 eV are used. The ITO film is irradiated with these energized beams at an energy density of 1 mW/cm² to 1 W/cm² for oxygen ions or 1 W/cm to 10 W/cm² for electrons so that the work function increases without an increase in area resistance of the ITO film. Thus, the function of the electrode, that is, charge injection of the organic luminescent device is enhanced.

Alternatively, the anode is subjected to an inert gas plasma surface treatment prior to the deposition of the organic layer in order to reduce surface irregularity of the ITO film and improve adhesiveness of the organic layer to the ITO film.

In such a case, the ITO film is irradiated with positive ions of preferably 20 to 200 eV and more preferably 30 to 60 eV at an energy density of 10 mW/cm² to 1 W/cm² so that the surface contamination is removed without an increase in area resistance of the ITO film and the adhesiveness of the organic layer is further enhanced.

The preferred embodiments of the present invention will now be described in further detail with reference to the drawings.

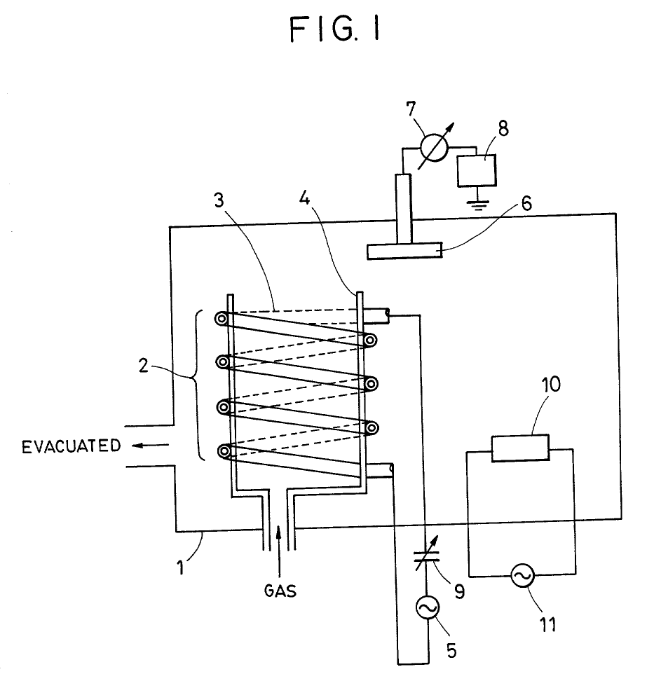

FIG. 1 is a schematic view of an apparatus for making an organic luminescent device based on the method in accordance with the present invention. This apparatus is used for surface treatment of an anode of an ITO film and deposition of an organic layer.

The apparatus has a chamber 1. The apparatus further includes a discharge tube 2 of a quartz tube 4 surrounded by a high-frequency coil 3, and a substrate holder 6 which holds a substrate having an ITO film to be surface-treated (ITO substrate) in the chamber 1. The substrate holder 6 is connected to an ammeter 7 and a DC power source 8 while the high-frequency coil 3 is connected to a high-frequency power source 5 and a capacitor 9.

The discharge tube 2 is provided with a nozzle (not shown in the drawing) which is connected to an gaseous oxygen suppler via a mass flow controller (these are not shown in the drawing). The chamber 1 is connected to a vacuum evacuation system (not shown in the drawing) to maintain the chamber at a predetermined vacuum. A glass substrate having an ITO film is attached to the substrate holder 6 and then the chamber 1 is evacuated to approximately 10⁻³ to 10⁻⁴ Pa.

Gaseous oxygen is supplied to the discharge tube 2 through the mass flow controller at a flow rate of 10 ccm while the pressure is regulated to 4×10⁻¹ Pa (3×10⁻³ Torr) and a high-frequency electrical power of 13.56 MHz is applied so that plasma is generated in the discharge tube 2 by electrodeless discharge. When a voltage is applied from the DC power source 8 to the substrate holder 6, the surface of the ITO substrate on the substrate holder 6 is irradiated with oxygen ions or electrons in the plasma. The surface of the ITO film is thereby modified.

Then, an evaporation source 10 containing an organic substance is immediately heated by an AC power source 11 to evaporate the organic substance, while a positive DC voltage is applied to the substrate holder 6 to deposit an organic layer. Furthermore, a cathode is provided to complete the organic luminescent device of the present invention.

In the inert gas plasma treatment, an inert gas, such as argon or neon, is supplied instead of gaseous oxygen. A mixture of gaseous oxygen and an inert gas may also be used.

In the present invention, another plasma generating method using a pressure-gradient plasma gun may be used instead of the plasma generating method for extracting ions or electrons using the high-frequency discharge apparatus shown in FIG. 1.

In the surface treatment of the present invention, the plasma density generated is preferably in the range of 10⁹ to 10¹³ cm⁻³ and more preferably in the range of 10¹⁰ to 10¹² cm⁻³ so that the ITO film is not damaged.

The present invention will now be described in further detail with reference to the drawings.

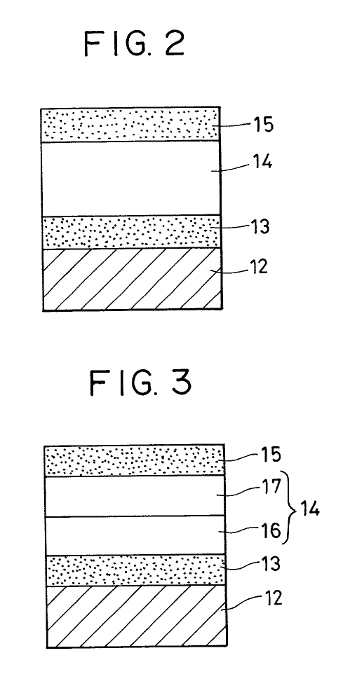

FIG. 2 is a cross-sectional view of an embodiment of the organic luminescent device in accordance with the present invention. An anode 13, a luminescent layer 14 and a cathode 15 are formed on a substrate 12, in that order. In such a configuration, a usable luminescent layer 14 is generally composed of a single compound having hole transportability, electron transportability, and luminescence, or a mixture of compounds each having one of these properties.

FIG. 3 is a cross-sectional view of another embodiment of the organic luminescent device in accordance with the present invention. An anode 13, a hole transport layer 16, an electron transport layer 17 and a cathode 15 are formed on a substrate 13, in that order. The hole transport layer 16 and the electron transport layer 17 function as a luminescent layer 14. In such a configuration, a usable hole transport layer 16 is generally composed of a luminescent material having hole transportability or a mixture including such a material and a non-luminescent material having hole transportability. The luminescent and non-luminescent materials may also have electron transportability. The electron transport layer 17 may be composed of a luminescent material having electron transportability or a mixture including such a material and a non-luminescent material having electron transportability. The luminescent and non-luminescent materials may also have hole transportability.

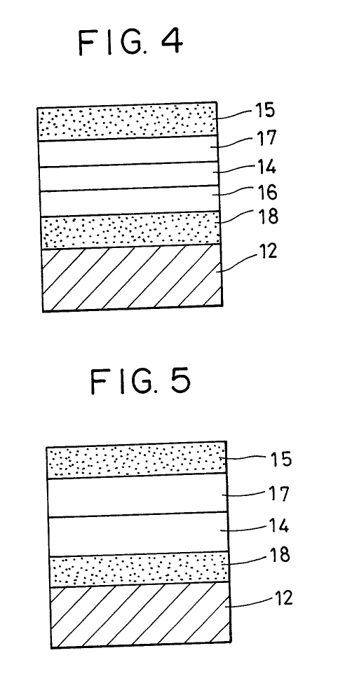

FIG. 4 is a schematic cross-sectional view of a further embodiment of the organic luminescent device in accordance with the present invention. An anode 13, a hole transport layer 16, a luminescent layer 14, an electron transport layer 17, and a cathode 15 are formed on a substrate 12 in that order.

FIG. 5 is a cross-sectional view of another organic luminescent device in accordance with the present invention. An anode 13, a luminescent layer 14, a electron transport layer 17, and a cathode 15 are formed on a substrate 12, in that order.

In the configurations shown in FIGS. 4 and 5, carrier transport and luminescence are performed in the individual layers. Such configurations permit a wide variety of combinations of a material having excellent hole transportability, a material having excellent electron transportability, and a material having excellent luminescence. Further, the configurations permit the use of various compounds which emit light at different wavelengths; hence the hue of the luminescent light can be controlled over a wide range. Effective traps of holes and electrons (or excimers) in the central luminescent layer will increase the luminescent efficiency.

The organic luminescent device produced by the method of the present invention exhibits superior hole injection ability and hole transportability compared with conventional organic luminescent devices. The organic luminescent device in the present invention may have any of the layer configurations shown in FIGS. 2 to 5.

In the organic luminescent device having an anode of the surface-modified ITO film which is produced by the above method of the present invention, the electrode and the adjoining organic layer form an optimized electronic matching state, resulting in increased carrier injection and significantly enhanced luminescent intensity.

As components of the organic layer in the organic luminescent device in accordance with the present invention, hole transport compounds studied in the field of electrophotographic photosensitive members, polymeric hole transport compounds (for example, shown as Compounds 1 to 4), dopant luminescent compounds (for example, shown as Compounds 5 and 6), electron transport compounds, and known luminescent electron transport compounds (for example, shown as Compounds 7 to 11) can be used. These compounds are used alone or in combination.

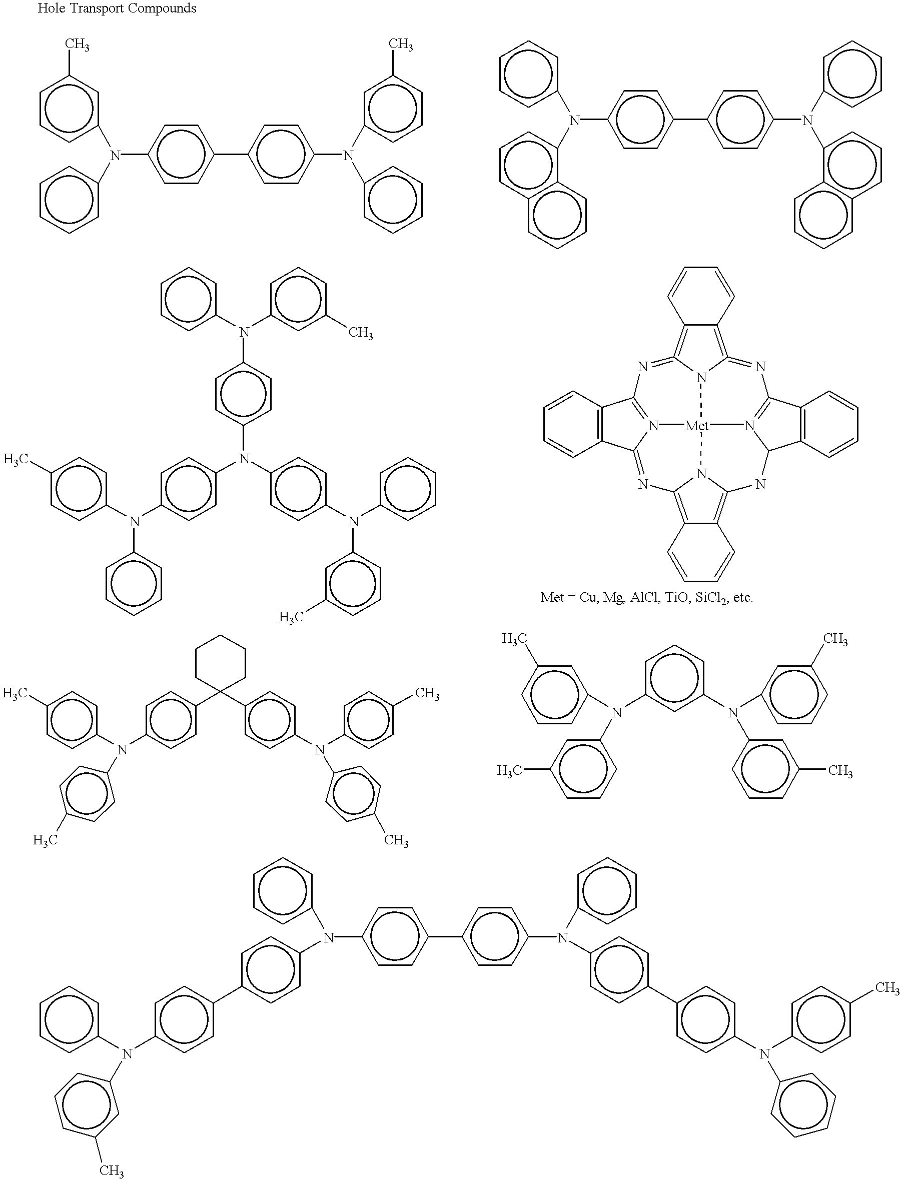

The organic layer of the organic luminescent device is formed by a general dry process, for example, a resistance heating or laser ablation process, in the present invention.

Preferable anode materials have large work functions. Examples of such materials include nickel, gold, platinum, palladium, selenium, rhenium, and iridium; alloys thereof; and tin oxide, indium tin oxide (ITO), and copper iodide. Conductive polymers, such as poly(3-methylthiophene), polyphenylene sulfide and polypyrrole are also usable. Among these, indium tin oxide (ITO) having noticeable effects is preferable in the present invention.

In contrast, preferable cathode materials have small work functions. Examples of such materials include silver, lead, tin, magnesium, aluminum, calcium, manganese, indium and chromium, and alloys thereof.

The organic luminescent device of the present invention is a perfect solid-state device having a large area, high resolution, a small thickness, a reduced weight, and being capable of high-speed operation, unlike conventional incandescent lamps, fluorescent lights, and light-emitting diodes. Thus, this organic luminescent device can be used in electroluminescent (EL) panels which can meet severe requirements.

The present invention is described in further detail with reference to the following examples.

### EXAMPLES 1 TO 7 AND COMPARATIVE EXAMPLE 1

An indium tin oxide (ITO) film with a thickness of 110 nm was deposited on a glass substrate by a sputtering process. The ITO substrate was held on the substrate holder in the apparatus shown in FIG. 1.

After the chamber was evacuated to 1.3×10⁻⁴ Pa (1×10⁻⁶ Torr), a hole transport layer of the compound represented by formula (1) having a thickness of 40 nm, a luminescent layer of Alq3 having a thickness of 60 nm, and an aluminum cathode having a thickness of 200 nm were deposited by a vacuum evaporation process, in that order, to prepare a device for COMPARATIVE EXAMPLE 1.

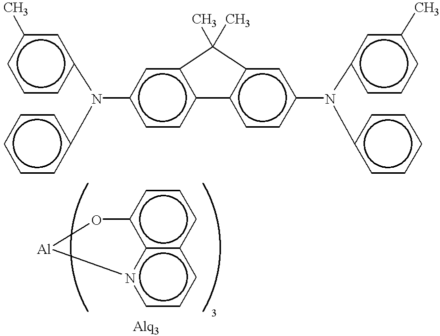

Devices for EXAMPLES 1 to 6 were prepared as in COMPARATIVE EXAMPLE 1, except that hole transport layers were formed while applying a voltage of 10, 20, 40, 70, 90, or 100 V to the substrate holder.

A device for EXAMPLE 7 was prepared as in COMPARATIVE EXAMPLE 1, except that a hole transport layer and a luminescent layer were deposited in that order while the voltage applied to the substrate holder was set at 70 V.

A voltage of 10 V was applied between the ITO and the cathode of each of the resulting devices to measure luminance. The results are shown in Table 1. As shown in Table 1, the luminance of the luminescent device in which the organic layer is formed while applying a positive DC voltage to the ITO substrate is significantly improved.

TABLE 1

| | Luminance (cd/cm²) |
|---|---|
| COMPARATIVE EXAMPLE 1 | 700 |
| EXAMPLE 1 | 900 |
| EXAMPLE 2 | 1,100 |
| EXAMPLE 3 | 1,600 |
| EXAMPLE 4 | 1,700 |
| EXAMPLE 5 | 1,500 |
| EXAMPLE 6 | 1,000 |
| EXAMPLE 7 | 2,200 |

### EXAMPLES 8 TO 15 AND COMPARATIVE EXAMPLE 2

An ITO substrate, which was the same as that shown in EXAMPLE 1, was held on the substrate holder in the apparatus shown in FIG. 1.

After the chamber was evacuated to 1.3×10⁻⁴ Pa (1×10⁻⁶ Torr), gaseous oxygen was supplied at a flow rate of 10 ccm through a mass flow controller so that the pressure in the discharge tube was 4×10⁻¹ Pa (1×10⁻³ Torr). Next, the high-frequency power source of 13.56 MHz was operated to generate an oxygen plasma in the discharge tube while a voltage of 40 V was applied to the substrate holder for 15 seconds to modify the surface of the ITO film.

After completion of the surface treatment, the gaseous oxygen flow was suspended and the chamber was evacuated to 1.3×10⁴ Pa (1×10⁻⁶ Torr). Then, a device for COMPARATIVE EXAMPLE 2 was prepared, as in COMPARATIVE EXAMPLE 1.

Devices for EXAMPLES 8 to 13 were prepared as in COMPARATIVE EXAMPLE 2, except that hole transport layers were formed while applying a voltage of 10, 20, 40, 70, 90, or 100 V to the substrate holder.

A device for EXAMPLE 14 was prepared as in COMPARATIVE EXAMPLE 2, except that the ITO substrate was treated while applying a voltage of −90 V to the substrate holder, and a hole transport layer was deposited while the voltage applied to the substrate holder was set at 50 V.

Moreover, a device for EXAMPLE 15 was prepared as in COMPARATIVE EXAMPLE 2, except that a hole transport layer and a luminescent layer were deposited in that order while the voltage applied to the substrate holder was set at 50 V.

A voltage of 10 V was applied between the ITO and the cathode of each of the resulting devices to measure luminance. The results are shown in Table 2. As shown in Table 2, the luminance of the luminescent device in which the organic layer is formed while applying a positive DC voltage to the ITO substrate is significantly improved.

TABLE 2

| | Luminance (cd/cm²) |
|---|---|
| COMPARATIVE EXAMPLE 2 | 3,700 |
| EXAMPLE 8 | 4,000 |
| EXAMPLE 9 | 4,500 |
| EXAMPLE 10 | 4,900 |
| EXAMPLE 11 | 5,500 |
| EXAMPLE 12 | 5,000 |
| EXAMPLE 13 | 4,200 |
| EXAMPLE 14 | 4,000 |
| EXAMPLE 15 | 6,800 |

### EXAMPLES 16 TO 22 AND COMPARATIVE EXAMPLE 3

An ITO substrate, which was the same as that shown in EXAMPLE 1, was held on the substrate holder in the apparatus shown in FIG. 1.

After the chamber was evacuated to 1.3×10⁻⁴ Pa (1×10⁻⁶ Torr), argon was supplied at a flow rate of 12 ccm through a mass flow controller so that the pressure in the discharge tube was 5.2×10⁻¹ Pa (4×10⁻³ Torr). Next, the high-frequency power source of 13.56 MHz was operated to generate an argon gas plasma in the discharge tube while a voltage of −50 V was applied to the substrate holder for 30 seconds to modify the surface of the ITO film.

After completion of the surface treatment, the argon gas flow was suspended and the chamber was evacuated to 1.3×10⁴ Pa (1×10⁻⁶ Torr). Then, a device for COMPARATIVE EXAMPLE 3 was prepared, as in COMPARATIVE EXAMPLE 1.

Devices for EXAMPLES 16 to 21 were prepared as in COMPARATIVE EXAMPLE 3, except that hole transport layers were formed while applying a voltage of 10, 20, 40, 70, 90, or 100 V to the substrate holder.

A device for EXAMPLE 22 was prepared as in COMPARATIVE EXAMPLE 3, except that the ITO substrate was treated while applying a voltage of −10 V to the substrate holder, and a hole transport layer was deposited while the voltage applied to the substrate holder was set at 50 V.

A voltage of 10 V was applied between the ITO and the cathode of each of the resulting devices to measure luminance. The results are shown in Table 3. As shown in Table 3, the luminance of the luminescent device in which the organic layer is formed while applying a positive DC voltage to the ITO substrate is significantly improved.

TABLE 3

| | Luminance (cd/cm²) |
|---|---|
| COMPARATIVE EXAMPLE 3 | 1,900 |
| EXAMPLE 16 | 2,300 |
| EXAMPLE 17 | 2,500 |
| EXAMPLE 18 | 3,100 |
| EXAMPLE 19 | 3,300 |
| EXAMPLE 20 | 3,000 |
| EXAMPLE 21 | 2,600 |
| EXAMPLE 22 | 2,300 |

### EXAMPLES 23 TO 28 AND COMPARATIVE EXAMPLE 4

An aluminum film having a thickness of 200 nm was deposited on a glass substrate by a vacuum deposition process. The aluminum substrate was held on the substrate holder in the apparatus shown in FIG. 1.

After the chamber was evacuated to 1.3×10⁻⁴ Pa (1×10⁻⁶ Torr), a luminescent layer of Alq₃ having a thickness of 70 nm and a hole transport layer composed of the above-described compound represented by formula (1) and having a thickness of 50 nm were deposited in that order by a vacuum evaporation process. Moreover, an ITO anode layer having a thickness of 100 nm was formed by an ion plating process to prepare a device for COMPARATIVE EXAMPLE 4.

Devices for EXAMPLES 23 to 28 were prepared as in COMPARATIVE EXAMPLE 3, except that luminescent layers were formed while applying a voltage of −10, −20, −40, −70, −90, or −100 V to the substrate holder.

A voltage of 10 V was applied between the ITO and the cathode of each of the resulting devices to measure luminance. The results are shown in Table 4. As shown in Table 4, the luminance of the luminescent device in which the organic layer is formed while applying a negative DC voltage to the aluminum substrate is significantly improved.

TABLE 4

| | Luminance (cd/cm²) |
|---|---|
| COMPARATIVE EXAMPLE 4 | 220 |
| EXAMPLE 23 | 450 |
| EXAMPLE 24 | 630 |
| EXAMPLE 25 | 700 |
| EXAMPLE 26 | 840 |
| EXAMPLE 27 | 800 |
| EXAMPLE 28 | 440 |

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for making an organic luminescent device comprising the steps of:
forming a first electrode on a substrate;
forming an organic layer on the first electrode; and
forming a second electrode on the organic layer;
wherein the organic layer is formed by applying a DC voltage to the first electrode without generating plasma.

2. A method for making an organic luminescent device according to claim 1, wherein the organic layer is formed by a dry process.

3. A method for making an organic luminescent device according to claim 1, wherein the organic layer is formed by a deposition process using resistance heating or laser ablation.

4. A method for making an organic luminescent device according to claim 1, wherein the first electrode is driven as an anode of the organic luminescent device.

5. A method for making an organic luminescent device according to claim 4, wherein the anode comprises indium tin oxide.

6. A method for making an organic luminescent device according to claim 4, wherein the DC voltage is a positive DC voltage.

7. A method for making an organic luminescent device according to of claim 1, wherein the first electrode is driven as a cathode of the organic luminescent device.

8. A method for making an organic luminescent device according to claim 7, wherein the DC voltage is a negative DC voltage.

9. A method for making an organic luminescent device according to claim 1, wherein the first electrode is subjected to an oxygen plasma surface treatment or an inert gas plasma surface treatment, and then the organic layer is formed while the first electrode is driven as an anode of the organic luminescent device without exposing the first electrode to air.

10. A method for making an organic luminescent device according to claim 9, wherein oxygen ions or electrons having an energy in the range of 10 to 80 eV are used in the oxygen plasma surface treatment.

11. A method for making an organic luminescent device according to claim 9, wherein positive ions of the inert gas having an energy in the range of 20 to 100 eV are used in the inert gas plasma surface treatment.

12. A method for making an organic luminescent device according to claim 1, wherein the DC voltage is in the range of 10 to 100 V.

13. A method for making an organic luminescent device according to claim 1, wherein the DC voltage is in the range of 40 to 90 V.

14. A method for making an organic luminescent device comprising a pair of electrodes and an organic layer provided therebetween, the method comprising evaporating an organic compound while applying a potential to one of the electrodes to form the organic layer on said one of the electrodes without generating plasma.

15. A method for making an organic luminescent device according to claim 14, wherein the organic compound is evaporated by resistance heating or laser ablation.

16. A method for making an organic luminescent device according to claim 14, wherein said one of the electrodes is an anode.
